(19) United States
(12) Patent Application Publication
(10) Pub. No.: US 2026/0102722 A1
(43) Pub. Date: Apr. 16, 2026

(54) FUEL FILTER

(71) Applicant: MAHLE International GmbH, Stuttgart (DE)

(72) Inventors: Alexandru Bogdan Ostafe, Timisoara (RO); Uli Haeussermann, Fellbach (DE); Sorin Jadaneantu, Timis (RO)

(21) Appl. No.: 19/356,033

(22) Filed: Oct. 10, 2025

(30) Foreign Application Priority Data
Oct. 11, 2024 (DE) 102024129392.6

(51) Int. Cl. B01D 29/15; B01D 35/30

(52) U.S. Cl. CPC B01D 29/15; B01D 35/30; B01D 2201/0415; B01D 2201/0453; B01D 2201/4076

(57) ABSTRACT

A fuel filter for filtering fuel for a motor vehicle may include a housing, a filter element arranged in the housing, and a hollow-cylindrical outlet neck arranged in the housing and in the filter element. The filter element may include a first end plate, a second end plate, a hollow-cylindrical filter body arranged therebetween, and a sealing tube arranged within the filter body. The outlet neck may be in fluid communication with an outlet of the housing at a first longitudinal end of the housing and/or may include an inlet opening facing away from the first longitudinal end of the housing. A first side of the sealing tube may be connected in a fluid-tight manner to the first end plate and a second side of the sealing tube may be disposed axially spaced apart from the first end plate and bear in a fluid-tight manner against the outlet neck.

### CROSS-REFERENCE TO RELATED APPLICATION

This application claims priority to German Patent Application No. DE102024129392.6, filed on Oct. 11, 2024, the contents of which is hereby incorporated by reference in its entirety.

### TECHNICAL FIELD

The invention relates to a fuel filter for filtering a fuel for a motor vehicle, comprising a housing and a filter element.

### BACKGROUND

A fuel filter typically comprises a housing and a filter element arranged within the housing. The filter element comprises a filter body made of a filter material and divides the housing into a filtered side and an unfiltered side. The fuel to be filtered then flows in the housing from the unfiltered side to the filtered side via the filter material of the filter body and is filtered. The filter element is designed to be replaceable. Unfortunately, when removing the filter element, unfiltered fuel on the unfiltered side can get onto the filtered side. This can cause the already filtered fuel to become contaminated with the unfiltered fuel.

### SUMMARY

It is therefore an object of the invention to provide, for a fuel filter of the generic type, an improved or at least alternative embodiment by which the disadvantages described are overcome.

According to the invention, this object is achieved by the subject matter of the independent claim(s). Advantageous embodiments are the object of the dependent claim(s).

The present invention is based on the fundamental idea of relocating a sealing point between the unfiltered side and the filtered side in such a way that the fuel cannot reach the filtered side when the filter element is removed.

The fuel filter according to the invention is configured for filtering a fuel for a motor vehicle. The fuel filter comprises a housing that has a first longitudinal end and a second longitudinal end with respect to its longitudinal central axis. Furthermore, the fuel filter comprises a filter element having a first end plate, a second end plate, and a hollow-cylindrical filter body. The filter body is arranged between the axially aligned end plates. The filter element is arranged coaxially in the housing, with the first end plate of the filter element facing the first longitudinal end of the housing and the second end plate of the filter element facing the second longitudinal end of the housing. Furthermore, the fuel filter comprises a hollow-cylindrical outlet neck, which is arranged coaxially in the housing and in the filter element. The outlet neck is in fluid communication with an outlet of the housing at the first longitudinal end of the housing and has an inlet opening facing away from the first longitudinal end of the housing. According to the invention, the filter element comprises a sealing tube which is arranged within the filter body and coaxially with the filter body. The sealing tube is connected to the first end plate on one side in a fluid-tight manner, and on the other side, the sealing tube is positioned at an axial distance from the first end plate and bears against the outlet neck in a fluid-tight manner.

In a conventional fuel filter, the filter element with the first end plate bears tightly against the outlet neck in a fluid-tight manner. This means that the filtered side and the unfiltered side in the conventional fuel filter are fluidically separated from one another at a sealing point formed between the first end plate of the filter element and the outlet neck. If the filter element is removed when changing the conventional fuel filter, the unfiltered fuel settles at the first longitudinal end and can flow around the outlet neck above the sealing point. After inserting the new filter element, the region above the sealing point is then on the filtered side and the unfiltered fuel reaches the filtered side. In the fuel filter according to the invention, the filter element with the sealing tube bears tightly against the outlet neck. This means that the filtered side and the unfiltered side are fluidically separated from one another at a sealing point formed between the sealing tube and the outlet neck. In contrast to conventional fuel filters, the sealing point is arranged at an axial distance from the first end plate or from the conventional sealing point. When the filter element is removed during replacement in the fuel filter according to the invention, the unfiltered fuel settles at the first longitudinal end. In this case, the unfiltered fuel can only flow around the outlet neck in a region below the sealing point. However, after inserting the new filter element, this region remains on the unfiltered side and the unfiltered fuel cannot reach the filtered side. This prevents the filtered fuel from becoming contaminated with unfiltered fuel when changing the filter element.

The filter element may in particular comprise the filter body made of a filtering material, such as nonwoven fabric and/or paper. The filter body can be connected axially on both sides to the end plates in a material-locking manner, for example by gluing. The sealing tube and/or the first end plate and/or the second end plate and/or the outlet neck and/or the housing may be made of plastic. The sealing tube can be connected to the first end plate in a material-locking manner, preferably by welding. An unfiltered side of the fuel filter can run around the filter body as well as between the first end plate and the first longitudinal end of the housing and between the outlet neck and the sealing tube from the first end plate to a sealing point formed between the sealing tube and the outlet neck. A filtered side of the fuel filter can extend within the filter body as well as between the filter body and the sealing tube.

The sealing tube can bear—in a fluid-tight manner—against the outlet neck between the inlet opening of the outlet neck and the first end plate and/or the first longitudinal end of the housing. In other words, the outlet neck can protrude axially from the sealing tube of the filter element, away from the first longitudinal end of the housing. The inlet opening of the outlet neck may be arranged outside the sealing tube of the filter element. This allows the inlet opening to be arranged within an interior of the filter element, and the filtered fuel to flow from the interior through the inlet opening into the outlet neck and on to the outlet of the housing.

The sealing tube can have at least one rib running around the longitudinal central axis facing the outlet neck, and the rib can then bear tightly against the outlet neck. Alternatively or additionally, the outlet neck facing the sealing tube may have at least one rib running around the longitudinal central axis, and the rib may then bear tightly against the sealing tube. The respective rib can improve the sealing connection between the sealing tube and the outlet neck in particular. It is conceivable that the sealing tube has exactly two ribs spaced axially apart from one another and the outlet neck has exactly one rib. The rib of the outlet neck can then be arranged axially between the two ribs of the sealing tube.

The axial height of the outlet neck may be more than 10%, preferably more than 30%, and particularly preferably more than 50% of the axial height of the housing. The outlet neck may extend from the first longitudinal end of the housing to the second longitudinal end of the housing, in particular via an axial center of the housing. Alternatively or additionally, the axial height of the sealing tube may be more than 10%, preferably more than 30%, and particularly preferably more than 50% of the axial height of the filter body. In particular, the sealing tube may extend from the first end plate to the second end plate of the filter element at least up to the axial center of the filter body. This allows a sealing point between the sealing tube and the outlet neck to be positioned at a sufficient distance from the first longitudinal end of the housing, thereby reliably preventing contamination of the filtered fuel with unfiltered fuel when changing the filter element.

The housing may have a first housing part at the first longitudinal end and a second housing part at the second longitudinal end. The first housing part and the second housing part can be detachably connected to one other, for example by screws, at a connection point of the housing that runs around the longitudinal central axis. The sealing tube can then extend axially from the first end plate to the second end plate of the filter element via the connection point. If the connection point is loosened and the filter element is removed for replacement, the unfiltered fuel can only fill the first housing part up to one edge of the first housing part or up to the loosened connection point. Since the sealing tube extends axially across the connection point, the unfiltered fuel cannot flow around a sealing point between the sealing tube and the outlet neck. This reliably prevents contamination of the filtered fuel with unfiltered fuel when changing the filter element.

The filter element may have a hollow-cylindrical support collar through which flow can pass radially. The support collar can be arranged coaxially with the filter body within the filter body. The support collar can be arranged between the filter body and the sealing tube in such a way that the filter body is supported radially inwardly by the support collar and the support collar is supported radially inwardly by the sealing tube. The filter body can bear against the support collar and be connected to it in a material-locking manner, for example by gluing. A gap between the support collar and the sealing tube can be 0.5 mm, for example. The support collar can be made of plastic, for example. The support collar can be connected to the end plates of the filter element, for example, in a material-locking manner. This can increase the rigidity of the filter element and reduce the risk of the filter element collapsing.

Channels through which the fuel can flow axially may be formed between the support collar and the sealing tube and/or between the support collar and the filter body. The channels allow the fuel flowing axially through the filter body opposite the sealing tube to be directed axially to the inlet opening of the outlet neck.

In the context of the present invention, the terms “axial” and “radial” and “coaxial” and “circumferential” always refer to the longitudinal central axis of the housing. In the fuel filter, the housing and/or the filter body and/or the support collar and/or the sealing tube and/or the outlet neck may be aligned coaxially to one another. The phrase “within a hollow-cylindrical element” is synonymous with the phrase “in a cavity formed within the hollow-cylindrical element”.

Further important features and advantages of the invention will become apparent from the dependent claims, from the drawings, and from the associated description of the figures with reference to the drawings.

It is understood that the features mentioned above and those to be explained below may be used not only in the combination indicated in each case, but also in other combinations or on their own, without departing from the scope of the present invention.

Preferred exemplary embodiments of the invention are shown in the drawings by way of example and are explained in more detail in the following description, wherein identical reference signs refer to identical or similar or functionally identical elements.

### BRIEF DESCRIPTION OF THE DRAWINGS

It shows, schematically in each case:

FIG. 1 shows a sectional view of a fuel filter according to the invention;

FIG. 2 shows a sectional view of the fuel filter according to the invention during replacement of a filter element;

FIG. 3 shows a sectional view of the filter element of the fuel filter according to the invention;

FIG. 4 shows a sectional view of a sealing tube of the filter element of the fuel filter according to the invention; and

FIG. 5 shows a sealing point of the fuel filter according to the invention.

### DETAILED DESCRIPTION

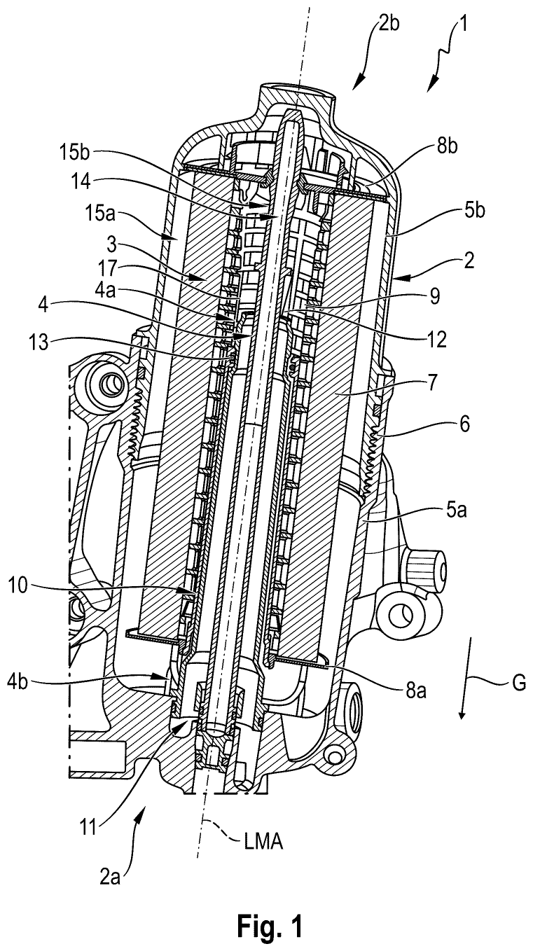

FIG. 1 shows a sectional view of a fuel filter 1 according to the invention for filtering a fuel for a motor vehicle. Fuel filter 1 comprises a housing 2, a hollow-cylindrical filter element 3, and a hollow-cylindrical outlet neck 4. In FIG. 1, the fuel filter 1 is aligned with respect to the force of gravity G in accordance with operating conditions.

The housing 2 comprises a first longitudinal end 2a and a second longitudinal end 2b, which are axially spaced apart with respect to a longitudinal central axis LMA of the housing 2. The housing 2 further comprises a first housing part 5a having the first longitudinal end 2a, and a second housing part 5b having the second longitudinal end 2b, which are detachably connected—in this case screwed—to one another at a circumferential connection point 6.

The filter element 3 comprises a hollow-cylindrical filter body 7, a first end plate 8a and a second end plate 8b, a hollow-cylindrical support collar 9, and a sealing tube 10. The sealing tube 10 is arranged within the support collar 9 and the support collar 9 is arranged within the filter body 7. The filter body 7, the support collar 9, and the sealing tube 10 are arranged coaxially with respect to one another and axially between the end plates 8a and 8b aligned perpendicular to the longitudinal central axis LMA. The filter body 7 and the support collar 9 extend over the entire axial height of the filter body 7 and are connected to the end plates 8a and 8b. The filter body 7 is supported radially inwardly on the support collar 9 and the support collar 9 is supported radially inwardly on the sealing tube 10. The sealing tube 10 is connected to the first end plate 8a—welded, for example—and extends approximately over an axial center of the filter body 7. The filter element 3 is arranged coaxially in the housing 2, such that the filter body 7, the support collar 9, and the sealing tube 10 are aligned coaxially to the housing 2.

The outlet neck 4 is arranged in sections within the sealing tube 10 of the filter element 3 and is aligned coaxially with the housing 2 and the filter element 3. The outlet neck 4 is in fluid communication, at its first axial end 4a, with an outlet 11 of the housing 2 formed at the first longitudinal end 2a, and protrudes out of the sealing tube 10 at its second axial end 4b. At the second end 4b, the outlet neck 4 comprises an inlet opening 12, which leads from an interior 17 of the filter element 3 into the outlet neck 4. The sealing tube 10 bears against the outlet neck 4 on the outside, such that a circumferential sealing point 13 is formed between the sealing tube 10 or the filter element 3 and the outlet neck 4. A vent tube 14 of the fuel filter 1 is also arranged coaxially within the outlet neck 4. The vent tube 14 connects the outlet 11 of the housing 2 with the surroundings at the second longitudinal end 2b of the housing 2.

Fuel filter 1 is configured to filter the fuel. The fuel flows to an unfiltered side 15a of the housing 2 and through the filter body 7 of the filter element 3 to a filtered side 15b of the housing 2. The unfiltered side 15a of the housing 2 here comprises a region surrounding the filter element 3 on the outside, and a region arranged between the first longitudinal end 2a of the housing 2 and the end plate 8a of the filter element 3. Furthermore, the unfiltered side 15a here comprises a region that is arranged between the sealing tube 10 and the outlet neck 4, and extends axially from the first end plate 8a to the sealing point 13.

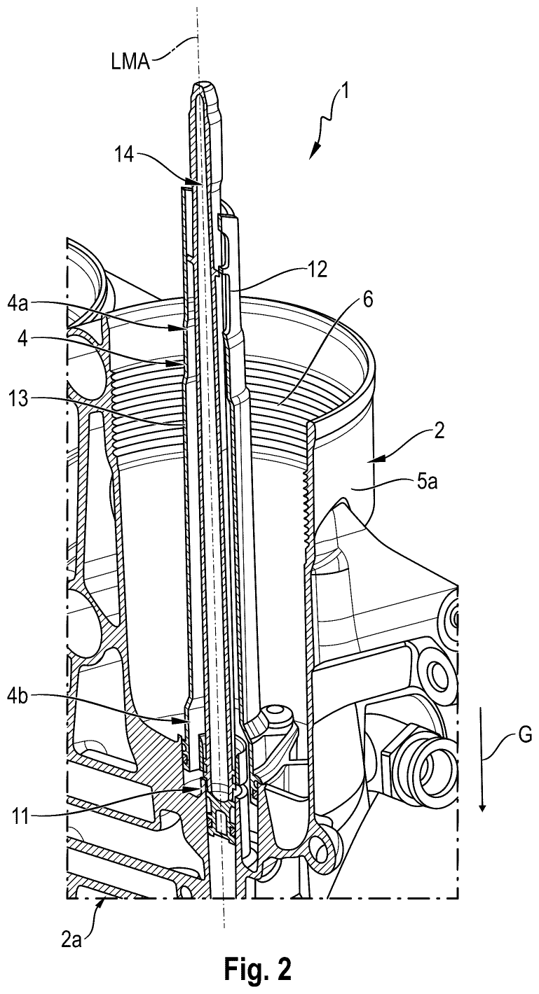

FIG. 2 shows a sectional view of the fuel filter 1 according to the invention during replacement of the filter element 3. Here, the second housing part 5b has been detached from the first housing part 5a at the connection point 6, and the filter element 3 has been removed from the housing 2. In FIG. 2, fuel filter 1 is aligned with respect to the force of gravity G in accordance with operating conditions.

If the filter element 3 is removed from the fuel filter 1 during replacement, as shown in FIG. 2, the unfiltered fuel settles at the bottom of the first housing part 5a. The sealing point 13 is designed in such a way that the unfiltered fuel can only flow around the outlet neck 4 in the region below the sealing point 13. When the new filter element 3 is inserted into the housing 2—as shown in FIG. 1—the region of the outlet neck 4 around which the unfiltered fuel flows is located on the unfiltered side 15b. This prevents unfiltered fuel from entering the filtered side 15b even when the filter element 3 is being replaced, thereby protecting the filtered fuel from contamination.

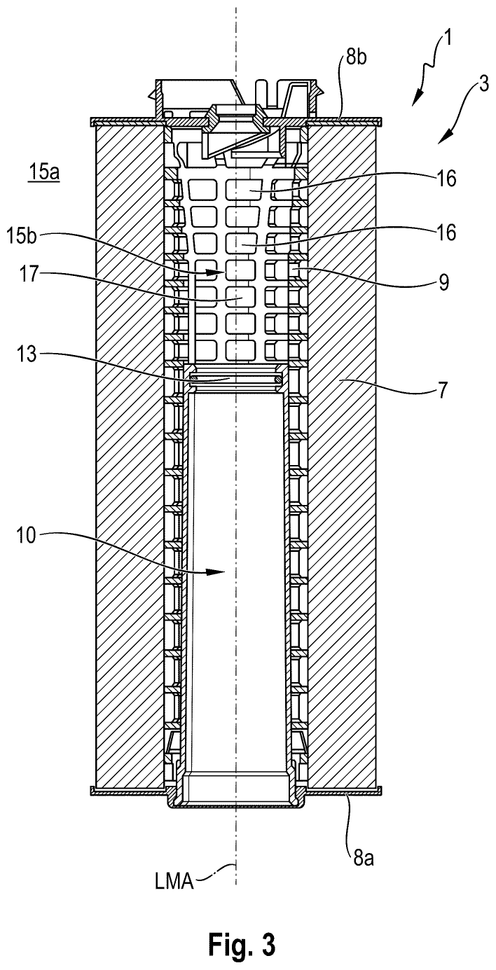

FIG. 3 shows a sectional view of the filter element 3 of the fuel filter 1 according to the invention. As can be seen particularly clearly here, the sealing tube 10 does not extend over the entire axial height of the filter body 7. It can also be seen that the support collar 9 comprises several radial openings 16. Through the openings 16, the fuel filtered in the filter body 7 can enter the interior 17 of the filter element 3 and flow through the inlet opening 12 of the outlet neck 4 into the outlet neck 4 and to the outlet 11 of the housing 2.

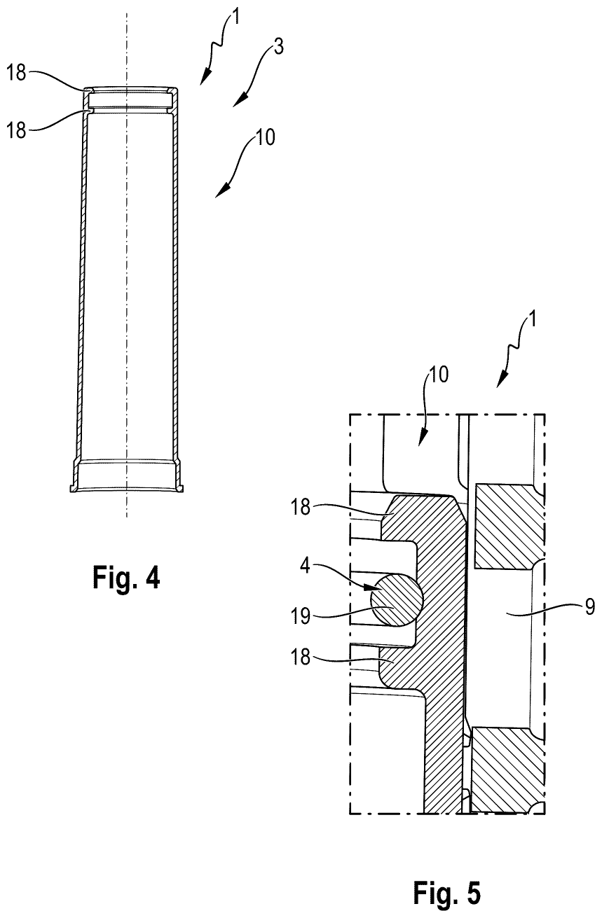

FIG. 4 shows a sectional view of the sealing tube 10 of the filter element 3 of the fuel filter 1 according to the invention. As can be seen particularly clearly in FIG. 4, the sealing tube 10 has two circumferential ribs 18 spaced axially apart from one another. The ribs 18 are formed on the sealing tube 10 oriented towards the outlet neck 4.

FIG. 5 shows the sealing point 13 in the fuel filter 1 according to the invention. As can be seen here, the outlet neck 4 comprises a circumferential rib 19, which is arranged axially between the ribs 18 of the sealing tube 10. The ribs 18 and 19 enable a particularly secure seal on the filtered side 15b.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A fuel filter for filtering fuel for a motor vehicle, comprising:
a housing having a first longitudinal end, a second longitudinal end, and a longitudinal central axis;
a filter element including a first end plate, a second end plate, and a hollow-cylindrical filter body arranged axially between the first end plate and the second end plate;
the filter element arranged coaxially in the housing with the first end plate facing the first longitudinal end of the housing and with the second end plate facing the second longitudinal end of the housing;
a hollow-cylindrical outlet neck arranged coaxially in the housing and in the filter element;
the outlet neck, at the first longitudinal end of the housing, in fluid communication with an outlet of the housing;
the outlet neck including an inlet opening facing away from the first longitudinal end of the housing;
wherein the filter element further includes a sealing tube arranged within the filter body and disposed coaxially with the filter body; and
wherein the sealing tube is connected in a fluid-tight manner to the first end plate on a first side and, on a second side, is disposed axially spaced apart from the first end plate and bears in a fluid-tight manner against the outlet neck.

2. The fuel filter according to claim 1, wherein the sealing tube bears on the outlet neck in a fluid-tight manner at a location between i) the inlet opening of the outlet neck and ii) the first end plate and/or the first longitudinal end of the housing.

3. The fuel filter according to claim 1, wherein the sealing tube includes at least one rib extending circumferentially around the longitudinal central axis and the at least one rib bears against the outlet neck.

4. The fuel filter according to claim 3, wherein:
the at least one rib of the sealing tube includes exactly two ribs, the two ribs disposed spaced axially apart from one another;
the outlet neck includes exactly one rib extending circumferentially around the longitudinal central axis and bearing against the sealing tube; and
the rib of the outlet neck is arranged axially between the two ribs of the sealing tube.

5. The fuel filter according to claim 1, wherein an axial height of the outlet neck is at least 10% of an axial height of the housing.

6. The fuel filter according to claim 1, wherein:
the housing includes a first housing part disposed at the first longitudinal end and a second housing part disposed at the second longitudinal end;
the first housing part and the second housing part are detachably connected to one other at a connection point of the housing that extends circumferentially around the longitudinal central axis; and
the sealing tube extends axially from the first end plate to the second end plate via the connection point.

7. The fuel filter according to claim 1, wherein:
the filter element further includes a hollow-cylindrical support collar through which a flow is radially passable;
the support collar is arranged within the filter body and coaxially with the filter body; and
the support collar is arranged between the filter body and the sealing tube such that the filter body is supported radially inwardly by the support collar and the support collar is supported radially inwardly by the sealing tube.

8. The fuel filter according to claim 7, wherein a plurality of channels through which fuel is axially flowable are formed between the support collar and the sealing tube.

9. The fuel filter according to claim 1, wherein the sealing tube, the first end plate, the second end plate, the outlet neck, and/or the housing are composed of plastic.

10. The fuel filter according to claim 1, wherein the sealing tube is connected to the first end plate in a material-locking manner.

11. The fuel filter according to claim 1, wherein:
the outlet neck protrudes axially from the sealing tube of the filter element away from the first longitudinal end of the housing; and
the inlet opening of the outlet neck is arranged outside of the sealing tube of the filter element.

12. The fuel filter according to claim 1, wherein:
the outlet neck includes at least one rib extending circumferentially around the longitudinal central axis; and
the at least one rib bears against the sealing tube.

13. The fuel filter according to claim 12, wherein:
the sealing tube includes a plurality of ribs extending circumferentially around the longitudinal central axis and disposed axially spaced apart from one another, the plurality of ribs including a first rib and second rib that are arranged axially adjacent to one another; and
the at least one rib of the outlet neck is arranged axially between and axially spaced apart from the first rib and the second rib of the sealing tube.

14. The fuel filter according to claim 5, wherein the axial height of the outlet neck is at least 30% of the axial height of the housing.

15. The fuel filter according to claim 14, wherein the axial height of the outlet neck is at least 50% of the axial height of the housing.

16. The fuel filter according to claim 1, wherein an axial height of the sealing tube is at least 10% of an axial height of the filter body.

17. The fuel filter according to claim 16, wherein the axial height of the sealing tube is at least 30% of the axial height of the filter body.

18. The fuel filter according to claim 17, wherein the axial height of the sealing tube is at least 50% of the axial height of the filter body.

19. The fuel filter according to claim 7, wherein a plurality of channels through which fuel is axially flowable are formed between the support collar and the filter body.

20. The fuel filter according to claim 10, wherein the sealing tube is connected to the first end plate via a weld connection.
